(19) United States
(12) Patent Application Publication
(10) Pub. No.: US 2016/0152468 A1
(43) Pub. Date: Jun. 2, 2016

(54) Method of preparing a catalyst for Producing Hydrogen from Al/water system and utility thereof

(71) Applicant: CHUNG YUAN CHRISTIAN UNIVERSITY, Tao-Yuan (TW)

(72) Inventors: Hong-Wen Wang, Tao-Yuan City (TW); Ming-Ssu Chin, Tao-Yuan City (TW)

(21) Appl. No.: 14/617,120

(22) Filed: Feb. 9, 2015

(30) Foreign Application Priority Data
Nov. 28, 2014 (TW) 103141425

(51) Int. Cl. C01B 3/08; B01J 21/02; B01J 37/32; B01J 37/03; B01J 37/04; B01J 37/06

(52) U.S. Cl. CPC C01B 3/08; B01J 37/04; B01J 37/06; B01J 37/32; B01J 37/031; B01J 21/02

(57) ABSTRACT

The present invention discloses a method of preparing a catalyst for producing Hydrogen from Al/water system. The present invention is preparing a catalyst for producing Hydrogen from Al/water system, the rate which the catalyst for producing Hydrogen from Al/water system is far better than the commercial aluminum hydroxide. So the catalyst can quickly catalyze Al/water system for producing Hydrogen. By using special synthetic aluminum hydroxide as a catalyst to generate hydrogen can be very fast, without using any alloying elements or extreme corrosion conditions, can be realized.

### BACKGROUND OF THE INVENTION

1. Field of the Invention

The present invention is generally related to a method of preparing a catalyst for producing hydrogen from Al/water system, and more particularly to a method of preparing a catalyst o f aluminum hydroxide for producing hydrogen from Al/water system.

2. Description of the Prior Art

In recent years, due to increasing demand for clean energy and the storage system of mobile hydrogen, so that the hydrogen from the reaction of aluminum and water is possible to be an attractive production and research, such as thesis: P. P. Edwards, V. L. Kuznetsov, W. I. F. David, N. P. Brandon, “Hydrogen and fuel cells: Towards a sustainable energy future.” Energy Policy, Vol. 36, pp. 4356-4362, 2008. However, It is slow to generate hydrogen gas from aluminum/water system. This is due to a thin layer of aluminum oxide on the aluminum surface to hinder the reaction.

How does effectively accelerate the production of hydrogen, it can be used highly corrosive alkaline solution, such as sodium hydroxide at pH value>13 to reach. It is shown as thesis: D. Belitskus, “Reaction of Aluminum with Sodium Hydroxide Solution as a Source of Hydrogen,” J. Electrochemical Soc., Vol. 117, pp. 1097-1099, 1970.

For avoiding the severe corrosion conditions, it uses that the additives in sodium hydroxide solution, such as aluminum hydroxide (L. Soler, A. M. Candela, J. Macanas, M. Munoz, J. Casado, “Hydrogen generation by aluminum corrosion in seawater promoted by suspensions of aluminum hydroxide” Int. J. Hydrogen Energy, Vol. 34, pp. 8511-8518, 2009), Tin sodium (L. Soler, A. M. Candela, J. Macanas, M. Munoz, J. Casado,“Hydrogen generation from water and aluminum promoted by sodium stannate,” Int. J. Hydrogen Energy, Vol. 35, pp. 1038-1048, 2010 and H. B. Dai, G. L. Ma, H. J. Xia, P. Wang, “Reaction of aluminum with alkaline sodium stannate solution as a controlled source of hydrogen,” Energy Environ Sci., Vol. 4, pp. 2206-2212, 2011), activation treatment of aluminum (V. Rosenband, A. Gany, “Application of activated aluminum powder for generation of hydrogen from water” Int. J. Hydrogen Energy, Vol. 35, pp. 10898-10904, 2010), hot water (S. S. Razavi-Tousi, J. A. Szpunar. “Mechanism of Corrosion of Activated Aluminum Particles by Hot Water” Electrochimica Acta 127, 95-105, 2014), Calcium oxide (X. Y. Chen, Z. W. Zhao, M. M. Hao, D. Z. Wang, “Research of hydrogen generation by the reaction of Al-based materials with water” Journal of Power Sources 222, 188-195, 2013).

It is also used to improve the production of hydrogen in the activation treatment of the aluminum powder, such as Al—Ga alloys (J. T. Ziebarth, J. M. Woodall, R. A. Kramer, G. Choi, “Liquid phase-enabled reaction of Al—Ga and Al—Ga—In—Sn alloys with water” Int. J Hydrogen Energ Vol. 36, pp. 5271-5279, 2011 and W. Wang, X. M. Zhao, D. M. Chen, K. Yang, “Insight into the reactivity of Al—Ga—In—Sn alloy with water” Int. J Hydrogen Energ Vol. 37, pp. 2187-2194, 2012), Bismuth (F. Xu, L. X. Sun, X. F. Lan, H. L. Chu, Y. J. Sun, H. Y. Zhou, F. Li, L. N. Yang, X. L. Si, J. Zhang, S. Walter, Z. Gabelica, “Mechanism of fast hydrogen generation from pure water using Al—SnCl2 and Bi-doped Al—SnCl2 composites” Inter. J. Hydrogen Energy, 39. 5514-5521, 2014), milling additive such as tin (F. Xu, L. X. Sun, X. F. Lan, H. L. Chu, Y. J. Sun, H. Y. Zhou, F. Li, L. N. Yang, X. L. Si, J. Zhang, S. Walter, Z. Gabelica, “Mechanism of fast hydrogen generation from pure water using Al—SnCl2 and Bi-doped Al—SnCl2 composites” Inter. J. Hydrogen Energy, 39. 5514-5521, 2014), Or potassium chloride/sodium chloride (B. Alinejad, K. Mahmoodi, “A novel method for generating hydrogen by hydrolysis of highly activated aluminum nanoparticles in pure water,” Int. J. Hydrogen Energy, Vol. 34, pp. 7934-7938, 2009), etc.

γ-Aluminum oxide is a good modifier on the aluminum surface to helpfully generate hydrogen. In their study, the mixed powder of aluminum and (Al(OH) 3) is sintered to form a porous composites of aluminum/γ-Aluminum oxide (Z. Y. Deng, Y. F. Liu, Y. Tanaka, J. H. Ye, Y. Sakka, “Modification of Al Particle Surfaces by γ-Al2O3 and Its Effect on the Corrosion Behavior of Al,” J. Amer. Ceram. Soc., Vol. 88, No. 4, pp. 977-979, 2005 and Z. Y. Deng, Y. F. Liu, Y. Tanaka, H. W. Zhang, J. H. Ye, Y. Kagwa, “Temperature Effect on Hydrogen Generation by the Reaction of γ-Al2O3-Modified Al Powder with Distilled Water,” J. Amer. Ceram. Soc., Vol. 88, No. 10, pp. 2975-2977, 2005 and Z. Y. Deng, J. M. F. Ferreira, Y. Tanaka, J. H. Ye, “Physicochemical Mechanism for the Continuous Reaction of γ-Al203 Modified Aluminum Powder with Water,” J. Amer. Ceram. Soc., Vol. 90, No. 5, pp. 1521-1526, 2007 and Z. Y. Deng, Y. B. Tang, L. L. Zhu, Y. Sakka, J. H. Ye, “Effect of different modification agents on hydrogen-generation by the reaction of Al with water,” Int. J. Hydrogen Energy, Vol. 35, pp. 9561-9568, 2010). From his systematic study, it is known that the smaller size of the starting aluminum metal powder, higher temperatures and aluminum oxide coating to significantly contribute the aluminum/water system to generate hydrogen (C. S. Fang, W. Z. Gai, and Z. Y. Deng” Al Surface Modification by a Facile Route” J. Am. Ceram. Soc., 97 [1] 44-47, 2014 and W. Z. Gai, C. S. Fang and Z. Y. Deng” Hydrogen generation by the reaction of Al with water using oxides as catalysts” Int. J. Energy Res. 38, 918-925, 2014). They believe hydroxides and oxides will decompose water molecules, promote hydration for the passive oxide film of aluminum particle surface (W. Z. Gai, C. S. Fang and Z. Y. Deng” Hydrogen generation by the reaction of Al with water using oxides as catalysts” Int. J. Energy Res. 38, 918-925, 2014).

However, the above methods with the contamination, high cost, and an additional energy supply are poor way to produce hydrogen. Therefore, it is urgently necessary to more clean, low-cost and low-power mode to generate hydrogen.

### SUMMARY OF THE INVENTION

In light of the above background, in order to fulfill the requirements of industries, one object of the present invention is to provide a method of preparing a catalyst for producing hydrogen from Al/water system. Particularly, the present invention uses method of preparing a catalyst of aluminum hydroxide for producing hydrogen from Al/water system. In order to solve the currently problems in the industry, while improve the yield of basic nickel carbonate and upgrade technology.

In view of the above background of the invention in order to meet the requirements of the industry. The present invention is used the specific weight ratio of aluminum, catalyst and water to further improve the catalytic ability of aluminum/water system to generate hydrogen.

According to the above objectives, this present invention provides a method of preparing a catalyst for producing hydrogen from Al/water system, comprising: providing a solution of aluminum nitrate; providing a solution of sodium hydroxide; providing a first constant temperature, so that said solution of sodium hydroxide to maintain −10˜10° C.; providing a stirring, to mix said solution of sodium hydroxide; and performing a mixing procedure, so that said solution of aluminum nitrate is dropped and added into said solution of sodium hydroxide. The mentioned method of preparing a catalyst for producing hydrogen from Al/water system, further comprising: performing a centrifugal procedure, to centrifugate said solution of sodium hydroxide to obtain a precipitate; performing a acid washing procedure, to wash said precipitate by hydrochloric acid; performing a water washing procedure, to wash said precipitate by the deionized water; and performing a freeze-drying procedure, to freeze-dry said precipitate to form said catalyst.

Accordingly, in one embodiment, the molar ratio of said aluminum nitrate and said sodium hydroxide is 1:2 to 1:7. The molar ratio of said aluminum nitrate and said sodium hydroxide is 1:3-1:3.5-1:4-1:4.5 and 1:5. The mentioned solution of aluminum nitrate and said solution of sodium hydroxide are formed by the deionized water. The mentioned first constant temperature is −5˜5° C. The mentioned mixing procedure is over a period of 24 hours.

According to the above objectives, this present invention provides a method for applying a catalyst in aluminum/water system to generate hydrogen, comprising: providing a solution of a catalyst, wherein said catalyst is formed by a method of preparing a catalyst for producing hydrogen from Al/water system, comprising: providing a solution of aluminum nitrate; providing a solution of sodium hydroxide; providing a first constant temperature, so that said solution of sodium hydroxide to maintain −10˜10° C.; providing a stirring, to mix said solution of sodium hydroxide; providing a stirring, to mix said solution of said catalyst; performing a first mixing aluminum powder procedure, to add the aluminum powder into said solution of said catalyst; and performing a plural mixing aluminum powder procedure, to add the aluminum powder into said solution of said catalyst. The mentioned method for applying a catalyst in aluminum/water system to generate hydrogen, wherein said method of preparing a catalyst for producing hydrogen from Al/water system, further comprising: performing a centrifugal procedure, to centrifugate said solution of sodium hydroxide to obtain a precipitate; performing an acid washing procedure, to wash said precipitate by hydrochloric acid; performing a water washing procedure, to wash said precipitate by the deionized water; and performing a freeze-drying procedure, to freeze-dry said precipitate to form said catalyst.

Accordingly, in one embodiment, the molar ratio of said aluminum nitrate and said sodium hydroxide is 1:2 to 1:7. The molar ratio of said aluminum nitrate and said sodium hydroxide is 1:3-1:3.5-1:4-1: 4.5 and 1:5. The mentioned solution of aluminum nitrate and said solution of sodium hydroxide are formed by the deionized water. The mentioned first constant temperature is −5˜5° C. The mentioned mixing procedure is over a period of 24 hours.

Accordingly, in one embodiment, the mentioned solution of said catalyst is formed by the deionized water and by the above method. To generate hydrogen with temperature control, the weight ratio of said aluminum powder, said catalyst, said deionized water is 1:(1˜8):(14˜200) in said first mixing aluminum powder procedure. To generate hydrogen without temperature control, the weight ratio of said aluminum powder, said catalyst, said deionized water is 3:15:50 in said first mixing aluminum powder procedure. The mentioned aluminum powder is added after an interval of 30 seconds to 5 minutes in said first mixing aluminum powder procedure and said plural mixing aluminum powder procedure. The mentioned solution of said catalyst is pH 9-13. The weight of said aluminum powder is the same with the weight of said aluminum powder of said first mixing aluminum powder procedure in said plural mixing aluminum powder procedure.

### BRIEF DESCRIPTION OF THE DRAWINGS

FIG. 1 shows a follow chart of a method of preparing a catalyst for producing hydrogen from Al/water system according to one embodiment of the present invention;

FIG. 2 shows a hydrogen generation chart of a method for applying a catalyst in aluminum/water system to generate hydrogen according to one embodiment of the present invention;

FIG. 3 shows a hydrogen generation chart, no temperature-controlled production experiments, without using a catalyst according to one embodiment of the present invention;

FIG. 4 shows that the catalyst 1:4 synthesized in an ice bath is added to the reaction of the aluminum/water system, the yield of the hydrogen is 100% within 120 seconds according to one embodiment of the present invention;

FIG. 5 shows the catalyst 1:3.5 synthesized in an ice bath 3 gw aluminum/50 ml water systems to produce hydrogen than 95% in 100 seconds. In the second and third batch of continuous addition of aluminum, of which 95% of the hydrogen produced in 30 and 40 seconds respectively to complete, faster than the first batch of the addition of aluminum according to one embodiment of the present invention;

FIG. 6 shows the catalyst 1:4 synthesized in an ice bath 3 gw aluminum/50 ml water systems to produce hydrogen than 95% in 100 seconds. In the second and third batch of continuous addition of aluminum, of which 95% of the hydrogen produced in 60 seconds respectively to complete according to one embodiment of the present invention;

FIG. 7 shows X-ray diffraction test results of different molar ratio of the synthesis of the catalyst at room temperature according to one embodiment of the present invention;

FIGS. 8(a) and (b) show that uses the test of X-ray diffraction to compare the intensity of the catalyst synthesized at room temperature and the intensity of the catalyst synthesized at an ice bath, the intensity of the catalyst synthesized at an ice bath slightly reduces the strength;

FIG. 9 show the morphologies of various synthetic catalyst powder by field effect emission type scanning electron microscope (FE-SEM), according to one embodiment of the present invention;

FIG. 10(a) shows 1 gw aluminum and 200 ml deionized water conditions, hydrogen generation time, at 25-55° C. by a method for applying a catalyst in aluminum/water system to generate hydrogen according to one embodiment of the present invention; and

FIG. 10(b) shows a 25-55° C. reaction rate constant In (k) and the inverse temperature 1/T chart by a method for applying a catalyst in aluminum/water system to generate hydrogen according to one embodiment of the present invention;

### DESCRIPTION OF THE PREFERRED EMBODIMENTS

What is probed into the invention is a method of preparing a catalyst for producing hydrogen from Al/water system. Detail descriptions of the compositions, structures, elements and steps will be provided in the following in order to make the invention thoroughly understood. Obviously, the application of the invention is not confined to specific details familiar to those who are skilled in the art. On the other hand, the common compositions, structures, elements and steps that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

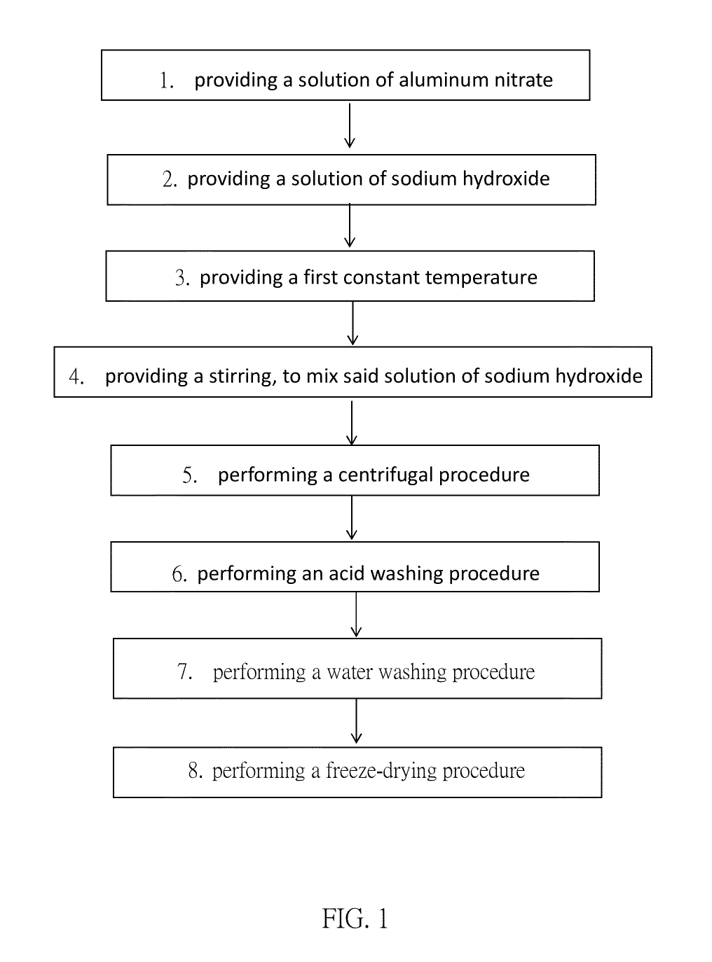

The first embodiment according to this specification discloses a method of preparing a catalyst for producing hydrogen from Al/water system, as shown in FIG. 1. The method of preparing a catalyst for producing hydrogen from Al/water system comprises the following steps: aluminum nitrate and sodium hydroxide are dissolved in a deionized water to form a solution of aluminum nitrate and a solution of sodium hydroxide. The solution of aluminum nitrate is dropped and added into a sodium hydroxide solution in stirring at −10˜30° C., over a period of 24 hours. Then, a white precipitate of aluminum hydroxide material is separated by centrifugation from the liquid. Subsequently, it is washed with the aqueous of hydrochloric acid. After, it is washed with the deionized water. The white precipitate of aluminum hydroxide material was freeze-dried to form the catalyst. According to the first embodiment, the molar ratio of aluminum nitrate and sodium hydroxide is 1:2 to 1:7 to produce the powder of aluminum hydroxide. In one preferred example, the deionized water is pH=0˜7.0 and resistance>18M Ω·cm.

In one embodiment according to this specification discloses a method of preparing a catalyst for producing hydrogen from Al/water system, as shown in FIG. 1. A method of preparing a catalyst for producing hydrogen from Al/water system comprises the following steps: aluminum nitrate and sodium hydroxide are dissolved in a deionized water of pH=0˜7.0 and resistance>18M Ω·cm to form a 0.1M solution of aluminum nitrate and 0.3˜0.5M solution of sodium hydroxide. The solution of aluminum nitrate is dropped by 0.5˜5 cm³ and added into the solution of sodium hydroxide in stirring at 5° C., over a period of 24 hours. Then, a white precipitate of aluminum hydroxide material is separated by centrifugation from the liquid. Subsequently, it is washed with the 0.01M aqueous of hydrochloric acid. After, it is washed with the deionized water. The white precipitate of aluminum hydroxide material was freeze-dried to form the catalyst. According to the one embodiment, the molar ratios of aluminum nitrate and sodium hydroxide are 1:3-1:3.5-1:4-1:4.5 and 1:5 to produce the powder of aluminum hydroxide.

The second embodiment according to this specification discloses a method for applying a catalyst in aluminum/water system to generate hydrogen. The method for applying a catalyst in aluminum/water system to generate hydrogen comprises the following steps: A catalyst is placed into the deionized water and mixed uniformly by shaking. Then, the first batch of aluminum powder is added to the mixture. Wherein the weight ratio of aluminum, catalyst and water is 1:(1-8):(14-200). The second batch of the aluminum powder is added after a period time that the first aluminum powder is added, the third batch of aluminum powder was added after a period time that the second aluminum powder is added. The aluminum powder is continued by the above a period time to add into the mixture in order to continuously produce hydrogen.

In one preferred example, the method for applying a catalyst in aluminum/water system to generate hydrogen comprises the following steps: A catalyst is placed into the deionized water and mixed uniformly by shaking. Then, the first batch of aluminum powder is added to the mixture. Wherein the weight ratio of aluminum, the mentioned catalyst and water is 3:15:50. The second batch of the aluminum powder is added after 30 seconds˜5 minutes that the first batch of aluminum powder is added, the third batch of aluminum powder was added after 30 seconds˜5 minutes that the second aluminum powder is added. The aluminum powder is continued by the above 30 seconds˜5 minutes to add into the mixture in order to continuously produce hydrogen.

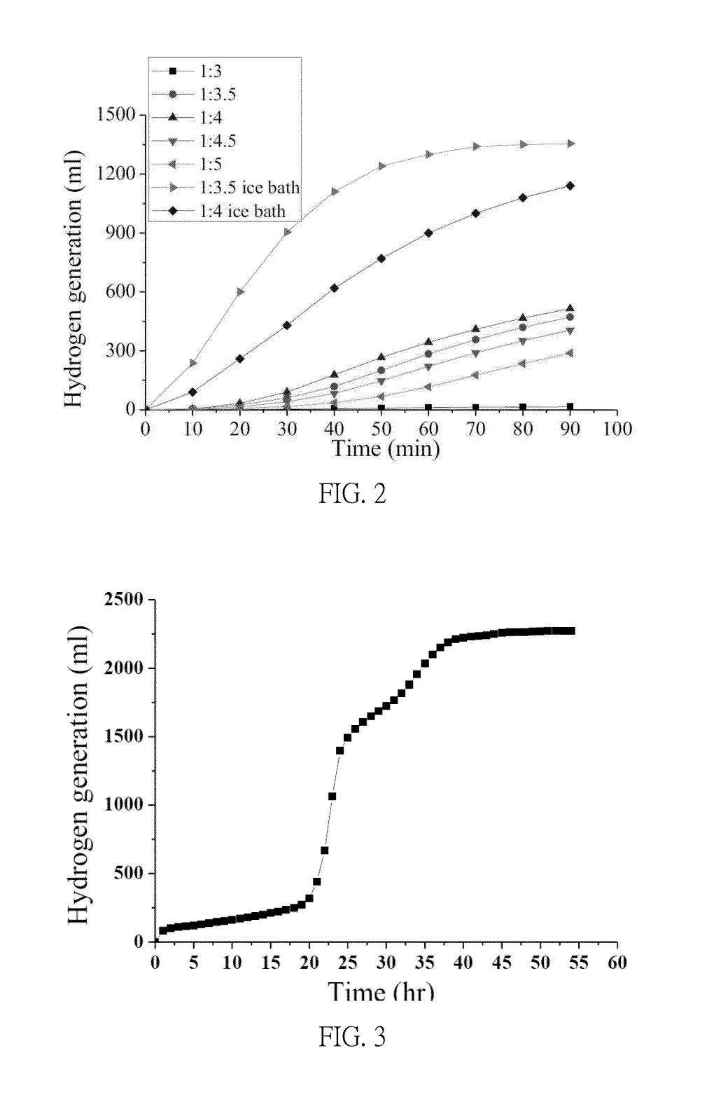

In one preferred example, as shown in FIG. 2. It is used that 1 gw aluminum powder and 1 gw the mentioned catalyst in 200 ml deionized water, i.e. a weight ratio of aluminum, the mentioned catalyst and water=1:1:200 at room temperature and pH˜9.5 to produce hydrogen. Wherein the mentioned catalyst is synthesized by the different conditions, such as the molar ratios of aluminum nitrate and sodium hydroxide are 1:3-1:3.5-1:4-1:4.5 and 1: 5. After, these 1:3-1:3.5-1:4-1:4.5 and 1:5 of the molar ratio of aluminum nitrate and sodium hydroxide are presented as the catalyst 1:3-the catalyst 1:3.5-the catalyst 1:4-the catalyst 1:4.5 and the catalyst 1:5. The catalyst1:3-the catalyst 1:4.5 and the catalyst 1:5 are relatively slow to generate hydrogen. The catalyst 1:3.5 and the catalyst 1:4 are relatively fast to generate hydrogen. Particularly, the catalytic ability of the catalyst 1:3.5 and the catalyst 1:4 are enhanced in an ice bath. As shown in FIG. 2, the conditions of the synthesis system at room temperature 20˜30° C. are presented without (ice bath) mark.

In one example, as shown in FIG. 3, it is no temperature-controlled production experiments, without using a catalyst to generate hydrogen, using 3 gw aluminum and 50 ml deionized water, and the conditions of pH=12.6. The reaction time exceeds 20 hours.

In one example, without using a catalyst, in a solution pH below 12, in 30 hours, it is hardly observed any significant hydrogen produced from 3 g of aluminum/50 ml of deionized water system.

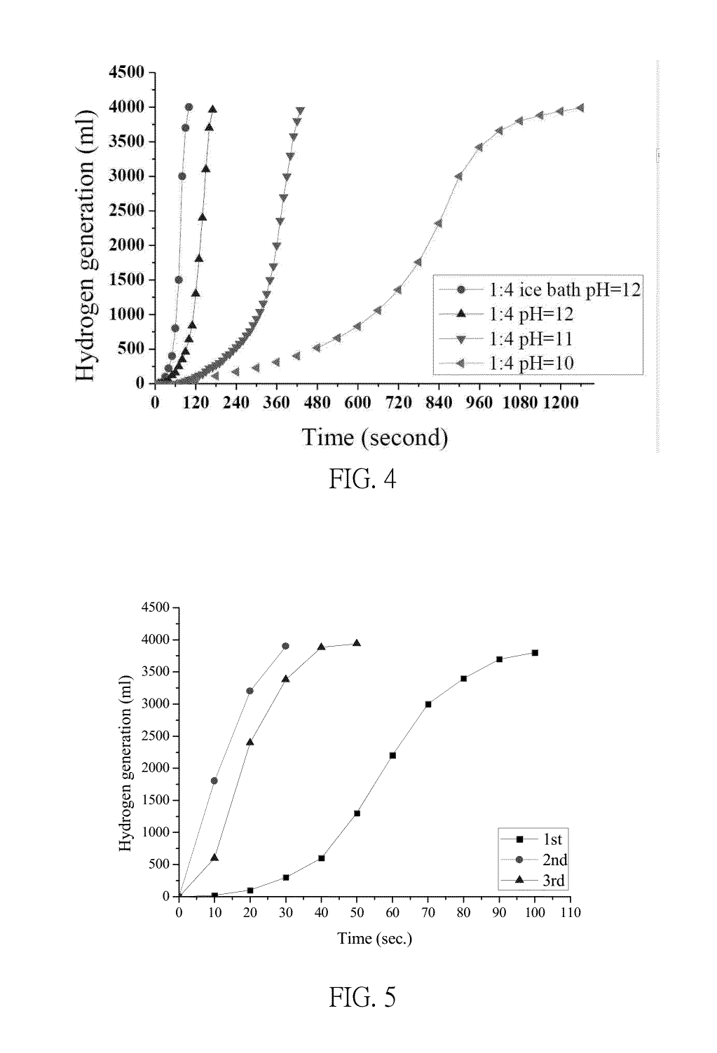

In one example, as shown in FIG. 4, when the catalyst 1:4 is added, the generating situation of hydrogen is significantly different. Clearly, when the catalyst 1:4 synthesized in an ice bath is added to the reaction of the aluminum/water system, the yield of the hydrogen is 100% within 120 seconds. As shown in FIG. 4, the conditions of the synthesis system at room temperature 20˜30° C. are presented without (ice bath) mark.

In one example, the hydrogen generation peak rate is 2000 ml per minute per 3 grams with the catalyst 1:4 and the reaction system of the weight ratio of aluminum, the mentioned catalyst and water of 3:15:50 in an ice bath.

In one example, as shown in FIG. 4, when the catalyst 1:4 synthesized at room temperature is added to the reaction of the aluminum/water system, the yield of the hydrogen is about 95% within 180 seconds.

In one example, as shown in FIG. 4, to use a catalyst at pH <12, 11 and 10 of a solution reaction, it will require more time to generate hydrogen. At these low pH conditions, it could not be observed rapidly generation of hydrogen without the catalyst.

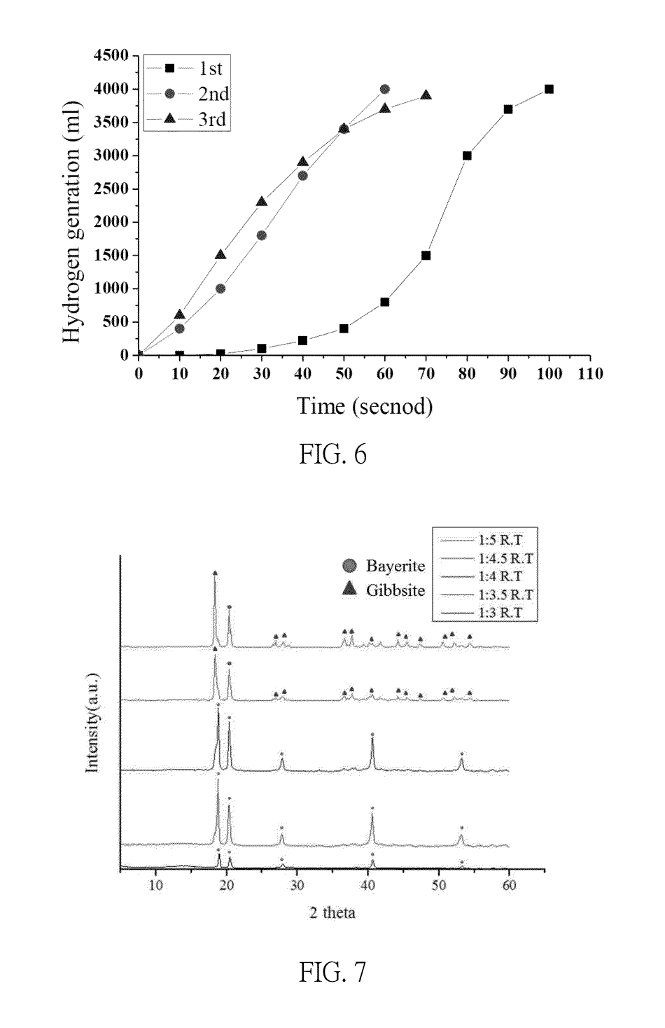

In one example, as shown in FIGS. 5 and 6. As shown in FIG. 5, The yield of the hydrogen is about 95% within 100 seconds when the first batch of 3 gw aluminum powder is added. In addition, when the second batch of 3 gw aluminum powder is added in the same solution, wherein the temperature of the mentioned solution is raised to over 70° C. since the reaction of the first batch of aluminum, the speed of generated hydrogen is even faster. When the temperature of the mentioned solution dropped slightly to 50° C., then the third batch of 3 gw aluminum powder is added in the mentioned solution. As shown in FIG. 5, it is still very fast that the yield of the hydrogen is over 95% within 40 seconds. A forming rate is faster due to continuously add aluminum by batch. It is also reached by the high temperature. As shown in FIG. 6, the catalytic effect of the catalyst 1:4 synthesized in an ice bath is quite similar to the catalytic effect of the catalyst 1:3.5 synthesized in an ice bath.

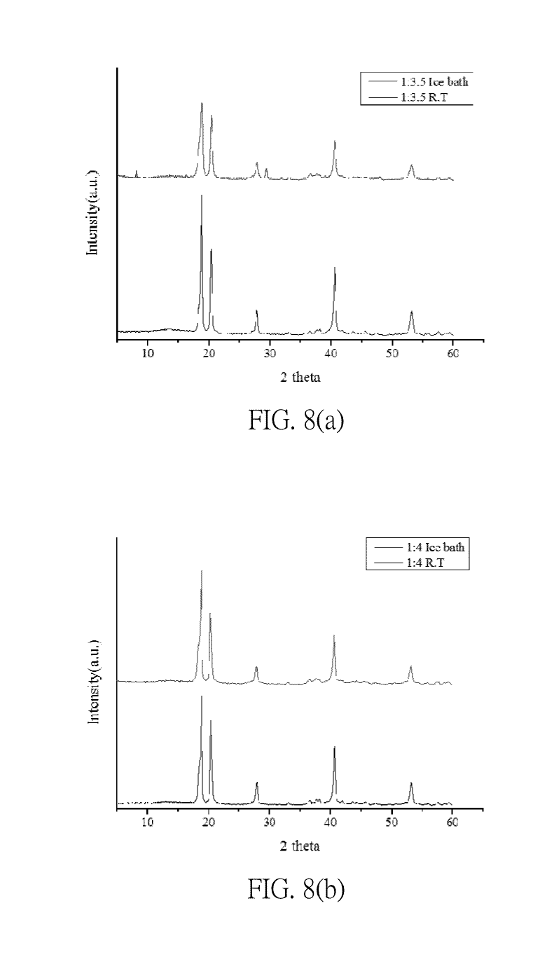

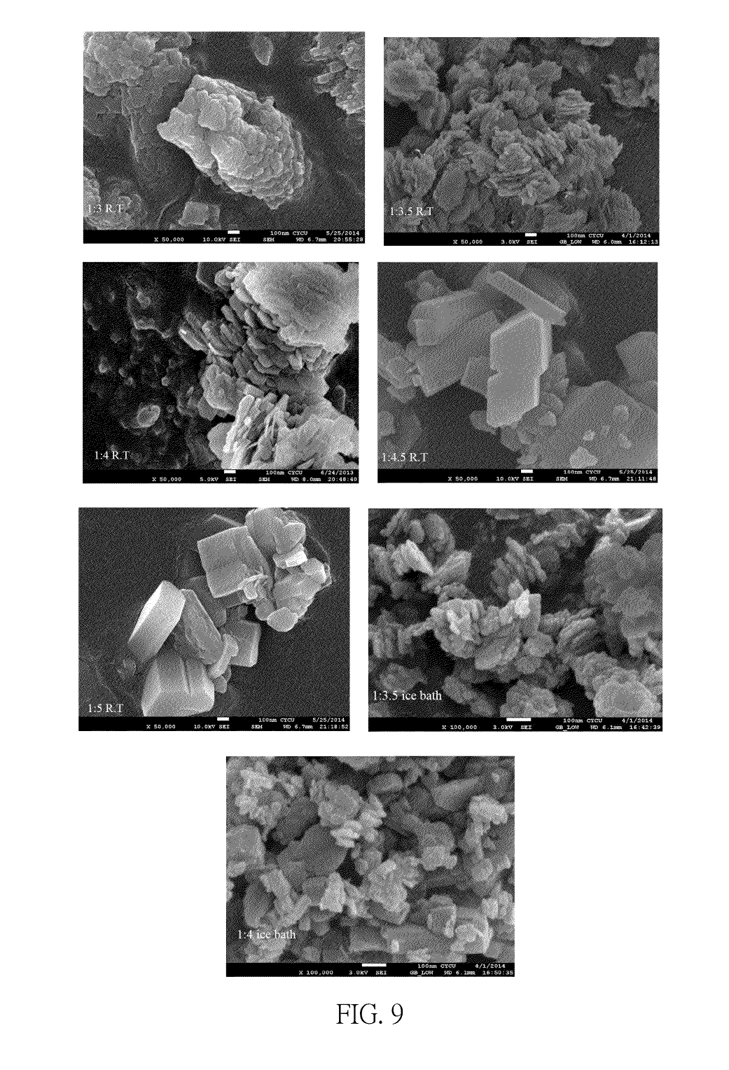

As shown in FIG. 7, the detection result of the catalyst powder synthesized by X-ray diffraction. All the synthesized catalyst powder is crystalline. The triangulation point is a gibbsite phase (α-phase). The dot point is a bayerite phase (β phase). Only the catalyst 1:3 is relatively weak. At the same temperature, in an ice bath, the vary phase of crystalline is get with the change of the ratio of aluminum nitrate and sodium hydroxide. As shown in FIG. 8, it uses the test of X-ray diffraction to compare the intensity of the catalyst synthesized at room temperature and the intensity of the catalyst synthesized at an ice bath, the intensity of the catalyst synthesized at an ice bath slightly reduces the strength. As shown in FIG. 7, it uses the higher concentration of sodium hydroxide to form a mixed-phase (α+β). However, because of their crystal structures are different, they are the bi-layer stack which is combined only by the OH⁻ and Al⁺³, thereby they are formed a three-dimensional crystal unit. As shown in FIG. 9, it is the morphology which are synthesized by a variety of aluminum hydroxide powder in field effect emission type scanning electron microscope (FE-SEM). The 1:4.5 R.T and the 1:5 R.T shown in the FIG. 9, the catalyst1:4.5 and the catalyst 1:5 synthesized at room temperature have large rod-like crystals. The 1:3.5 R.T and the 1:4 R.T shown in the FIG. 9, the catalyst 1:3.5 and the catalyst 1:4 synthesized at room temperature are flat plates. The 1:3 R.T shown in the FIG. 9, the catalyst 1:3 synthesized at room temperature shows small and round-shaped particles. The 1:3.5 ice bath and the 1:4 ice bath shown in the FIG. 9, the catalyst 1:3.5 and the catalyst 1:4 synthesized in an ice bath are flat plates which are much smaller than the flat plates of the catalyst1:3.5 and the catalyst 1:4 synthesized at room temperature. The plate crystals of the catalyst 1:3.5 and the catalyst 1:4 play an important role to generate hydrogen in the aluminum/water system. In addition, the edges of hexagonal tabular crystal structure are the active sites, it can dissociate water molecules into OH⁻ and H⁺. In an ice bath, the composite ratio of 1:3.5˜1:4 catalyst obtained a higher surface area of aluminum hydroxide, it is possible to further improve these plate crystals to generate hydrogen in aluminum/water system. As shown in Table 1, the surface area of the catalyst powder is derived by the combination ratio of 1:3.5 and 1:4. In the surface area of the catalyst powder, the combination ratio of 1:3.5 is higher than the combination ratio of 1:4. Wherein the above two conditions reduces the size of these plate crystals in an ice bath, so as to increase the activity of these plate crystals.

Furthermore, by the Arrhenius equation, the activation energy of different aluminum hydroxide, Arrhenius equation as follows: k=A·exp (−Ea/RT), slope=−Ea/R, where Ea is the activation energy. k is the rate constants at 25, 35, 45, and 55° C., using 200 ml deionized water to control system.

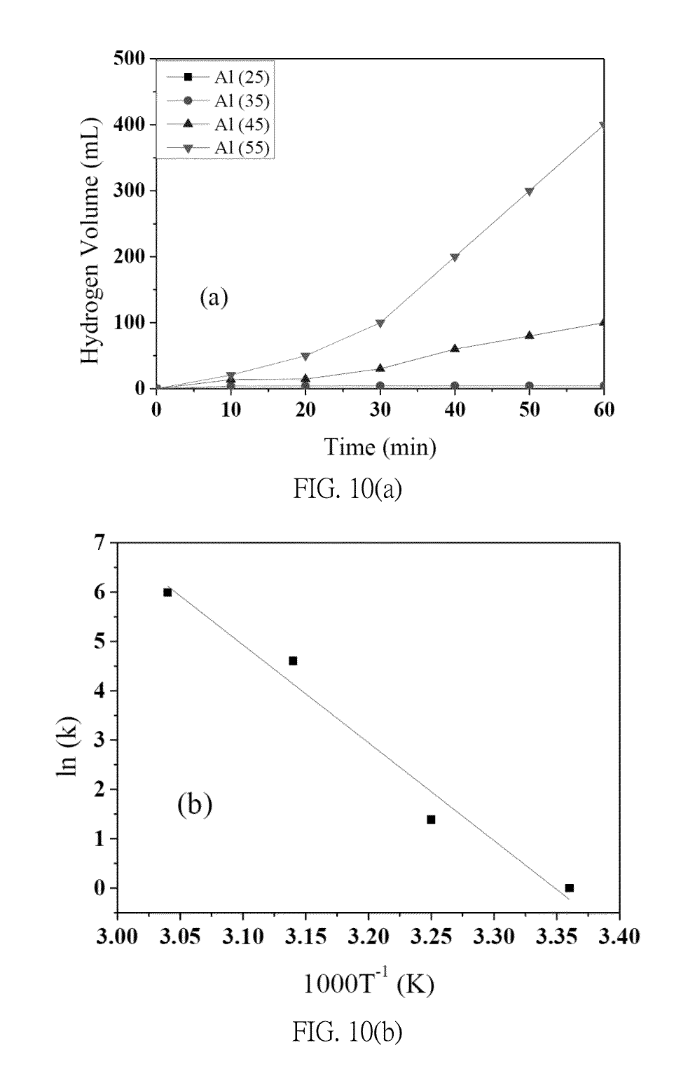

In one embodiment, as a FIG. 10(a) and (b) are shown, taking 1 gw pure aluminum in 200 ml deionized water. For pure aluminum without using a catalyst, the activation energy is 158 kJ/mole. When the catalyst is used in the case of 200 ml water system, in the manner described above, the calculation of activation energy of hydrogen produced. As shown in Table 1, Catalyst obtained at a composite ratio of 1:3.5˜1:4 catalyst in an ice bath has the lowest activation energy to generate hydrogen. These small and sharp edges of the aluminum hydroxide are random stacked by the hexagonal plate crystals, so that the crystal edges and corners are very active to dissociate the water molecules and form OH⁻ and H⁺.

TABLE 1

| catalyst | surface area (m²/g) | activation energy (kJ/mole) |
|---|---|---|
| 1:3.5 R.T | 23.19 | 45.14 |
| 1:3.5 ice bath | 39.86 | 33.25 |
| 1:4 R.T | 7 | 47.07 |
| 1:4 ice bath | 12.74 | 35.4 |

For the special form of the catalyst for the dense alumina-based protective layer on the aluminum particles react effectively, which helps make the following reaction:

Al₂O₃+Al(OH)₃→3AlO(OH) (2)

Boehmite (AlO (OH)) can be easily reacted with the aluminum, as follows:

2Al+6AlO(OH)→4Al₂O₃+3H₂ (3)

Use special synthetic catalysts, and in situ exothermic reaction of the aluminum/water system, whereby the solutions can reach the yield of hydrogen more than 95% in pH 12 within 100 sec.

It is apparent that based on the above descriptions of the embodiments, the present invention can have numerous modifications and alterations, and they should be construed within the scope of the following claims. In addition to the above detailed descriptions, the present invention can be widely applied to other embodiments. The above embodiments are merely preferred embodiments of the present invention, and should not be used to limit the present invention in any way. Equivalent modifications or changes can be made by those with ordinary skill in the art without departing from the scope of the present invention as defined in the following appended claims.

What is claimed is:

1. A method of preparing a catalyst for producing hydrogen from Al/water system, comprising:
providing a solution of aluminum nitrate;
providing a solution of sodium hydroxide;
providing a first constant temperature, so that said solution of sodium hydroxide to maintain −10˜10° C.;
providing a stirring, to mix said solution of sodium hydroxide; and
performing a mixing procedure, so that said solution of aluminum nitrate is dropped and added into said solution of sodium hydroxide.

2. A method of preparing a catalyst for producing hydrogen from Al/water system of claim 1, comprising:
performing a centrifugal procedure, to centrifugate said solution of sodium hydroxide to obtain a precipitate;
performing an acid washing procedure, to wash said precipitate by hydrochloric acid;
performing a water washing procedure, to wash said precipitate by the deionized water; and
performing a freeze-drying procedure, to freeze-dry said precipitate to form said catalyst.

3. A method of preparing a catalyst for producing hydrogen from Al/water system of claim 1, wherein the molar ratio of said aluminum nitrate and said sodium hydroxide is 1:2 to 1:7.

4. A method of preparing a catalyst for producing hydrogen from Al/water system of claim 1, wherein the molar ratio of said aluminum nitrate and said sodium hydroxide is 1:3-1:3.5-1:4-1:4.5 and 1:5.

5. A method of preparing a catalyst for producing hydrogen from Al/water system of claim 1, wherein said solution of aluminum nitrate and said solution of sodium hydroxide are formed by the deionized water.

6. A method of preparing a catalyst for producing hydrogen from Al/water system of claim 1, wherein said first constant temperature is −5˜5° C.

7. A method of preparing a catalyst for producing hydrogen from Al/water system of claim 1, wherein said mixing procedure is over a period of 24 hours.

8. A method for applying a catalyst in aluminum/water system to generate hydrogen, comprising:
providing a solution of a catalyst, wherein said catalyst is formed by a method of preparing a catalyst for producing hydrogen from Al/water system, comprising: providing a solution of aluminum nitrate;
providing a solution of sodium hydroxide; providing a first constant temperature, so that said solution of sodium hydroxide to maintain −10˜10° C.; providing a stirring, to mix said solution of sodium hydroxide;
providing a stirring, to mix said solution of said catalyst;
performing a first mixing aluminum powder procedure, to add the aluminum powder into said solution of said catalyst; and
performing a plural mixing aluminum powder procedure, to add the aluminum powder into said solution of said catalyst.

9. A method for applying a catalyst in aluminum/water system to generate hydrogen of claim 8, wherein said method of preparing a catalyst for producing hydrogen from Al/water system, comprising:
performing a centrifugal procedure, to centrifugate said solution of sodium hydroxide to obtain a precipitate;
performing an acid washing procedure, to wash said precipitate by hydrochloric acid;
performing a water washing procedure, to wash said precipitate by the deionized water; and
performing a freeze-drying procedure, to freeze-dry said precipitate to form said catalyst.

10. A method for applying a catalyst in aluminum/water system to generate hydrogen of claim 8, wherein the molar ratio of said aluminum nitrate and said sodium hydroxide is 1:2 to 1:7.

11. A method for applying a catalyst in aluminum/water system to generate hydrogen of claim 8, wherein the molar ratio of said aluminum nitrate and said sodium hydroxide is 1:3-1:3.5-1:4-1:4.5 and 1:5.

12. A method for applying a catalyst in aluminum/water system to generate hydrogen of claim 8, wherein said solution of said aluminum nitrate and said solution of sodium hydroxide are formed by the deionized water.

13. A method for applying a catalyst in aluminum/water system to generate hydrogen of claim 8, wherein said first constant temperature is −5˜5° C.

14. A method for applying a catalyst in aluminum/water system to generate hydrogen of claim 8, wherein said mixing procedure is over a period of 24 hours.

15. A method for applying a catalyst in aluminum/water system to generate hydrogen of claim 8, wherein said solution of said catalyst is formed by the deionized water.

16. A method for applying a catalyst in aluminum/water system to generate hydrogen of claim 8, wherein the weight ratio of said aluminum powder, said catalyst, said deionized water is 1:(1˜8): (14-200) in said first mixing aluminum powder procedure.

17. A method for applying a catalyst in aluminum/water system to generate hydrogen of claim 8, wherein the weight ratio of said aluminum powder, said catalyst, said deionized water is 3:15:50 in said first mixing aluminum powder procedure.

18. A method for applying a catalyst in aluminum/water system to generate hydrogen of claim 8, wherein said aluminum powder is added after an interval of 30 seconds to 5 minutes in said first mixing aluminum powder procedure and said plural mixing aluminum powder procedure.

19. A method for applying a catalyst in aluminum/water system to generate hydrogen of claim 8, wherein said solution of said catalyst is pH 9˜13.

20. A method for applying a catalyst in aluminum/water system to generate hydrogen of claim 8, wherein the weight of said aluminum powder is the same with the weight of said aluminum powder of said first mixing aluminum powder procedure in said plural mixing aluminum powder procedure.
